(19) United States
(12) Patent Application Publication
(10) Pub. No.: US 2020/0254368 A1
(43) Pub. Date: Aug. 13, 2020

(54) METHOD FOR UNCLOGGING AN EXTRUDER

(71) Applicant: Hubert Juillet, Willer sur Thur (FR)

(72) Inventor: Hubert Juillet, Willer sur Thur (FR)

(21) Appl. No.: 15/776,253

(22) PCT Filed: Nov. 11, 2016
(86) PCT No.: PCT/IB2016/001621

§ 371 Date: May 15, 2018

(30) Foreign Application Priority Data
Nov. 16, 2015 (FR) 15/02406

(51) Int. Cl. B01D 29/64; C02F 11/125; B01D 29/46; B30B 9/26; B30B 15/00

(52) U.S. Cl. CPC B01D 29/6476; C02F 11/125; B01D 29/46; C02F 2303/16; B30B 15/0082; C02F 2303/14; B30B 9/267

(57) ABSTRACT

A method for unclogging the openwork sheath of screw extruders used for sludge densification. The sheath is formed by a stack of superposed elements that are spaced apart from one another by elastic spacers, the latter creating a gap between each of the elements. The liquid and gaseous fractions contained in the sludge are expelled through the gaps. The stack is compressed during an extrusion cycle, with the spacers thus being squashed, thereby reducing the thickness of the gaps. During an unclogging cycle, the pressure is released, the spacers then returning to their original thicknesses and in this way increasing the size of the gaps, thus making it easier to unclog the latter.

The subject of the present invention as novel industrial product is an original method for unclogging the slotted barrels of screw extruders, which are intended for the filtration of liquid and/or gaseous fractions contained in a mix of these products and, among other things, in sludges.

Barrels of screw extruders are already known which consist of a stack of barrel elements or sections and which are more often than not simple washers spaced apart from one another by spacers which themselves are also washers but of smaller dimensions.

The distance thus created between said washers constitutes slots through which the finest fractions, including water, escape thus producing the densification of said mixtures and sludges.

From time to time, the supply to the extruder is stopped and water is injected counter-current into the barrel in order to unclog said slots.

These unclogging cycles are lengthy and fairly imperfect.

The present invention aims to remedy these drawbacks and relates to a slotted barrel of a screw extruder comprising means for enlarging said slots during the unclogging cycles.

The present invention will be clearly understood by referring to the description below and the attached drawings in which:

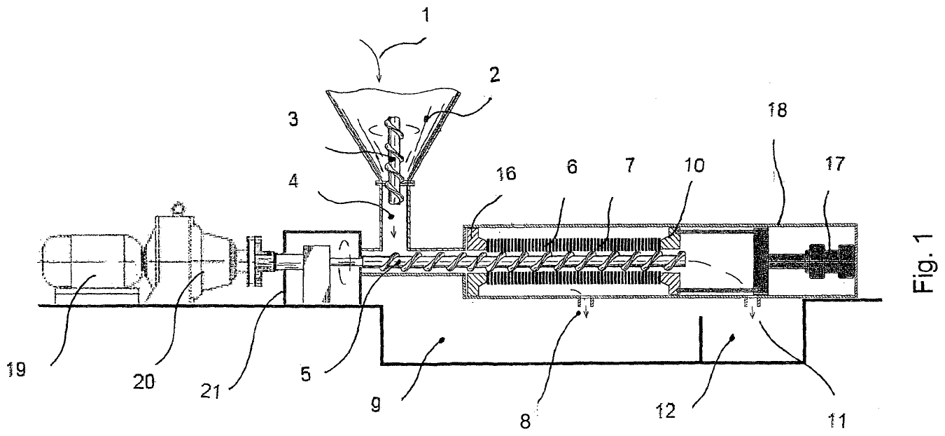

FIG. 1 is a general view of the present method operating during an extrusion cycle and in which said barrel and said screw are represented in cross section.

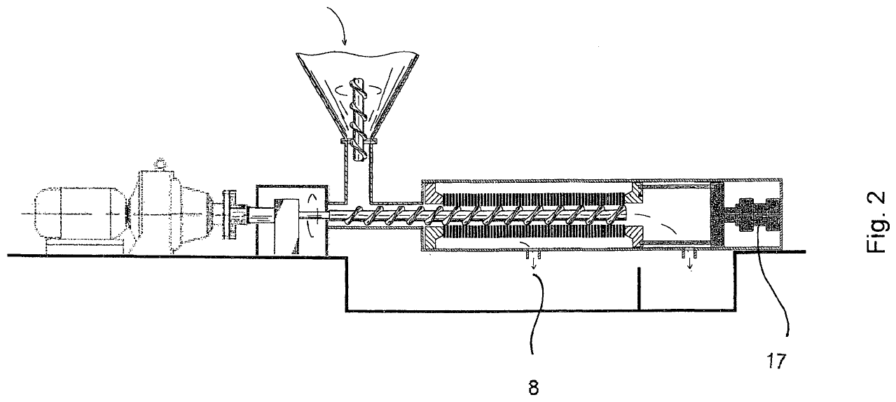

FIG. 2 is a general view of the present method operating during an unclogging cycle and in which said barrel and said screw are represented in cross section.

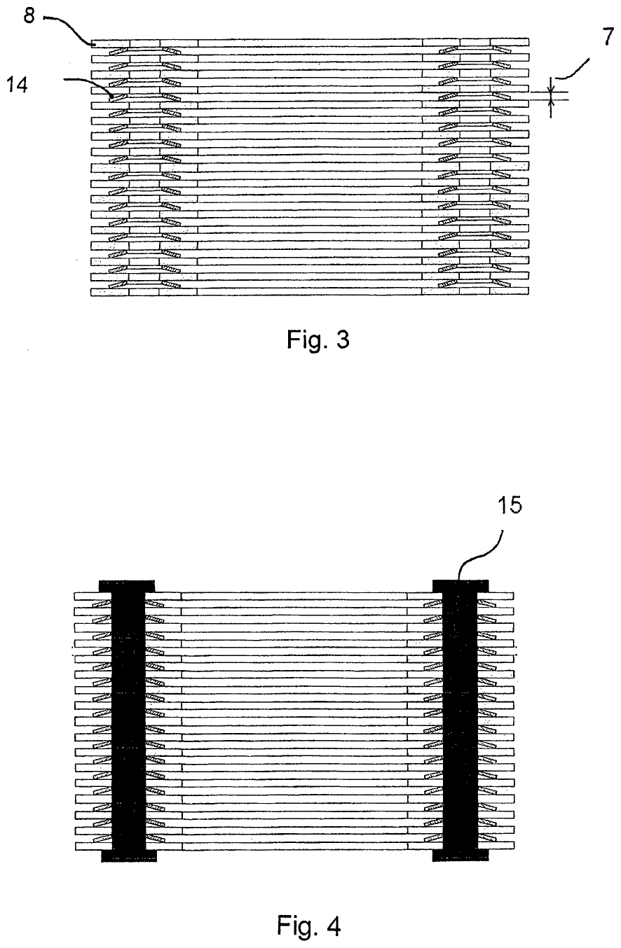

FIG. 3 is the cross section of a barrel during an unclogging cycle.

FIG. 4 is the cross section of a barrel during an unclogging cycle, which barrel is provided with holding columns.

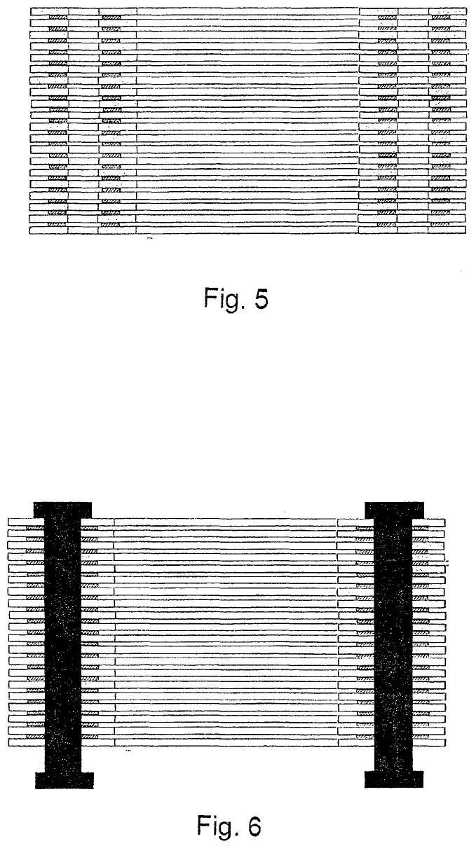

FIG. 5 is the cross section of a barrel during an extrusion cycle.

FIG. 6 is the cross section of a barrel during an extrusion cycle, which barrel is provided with holding columns.

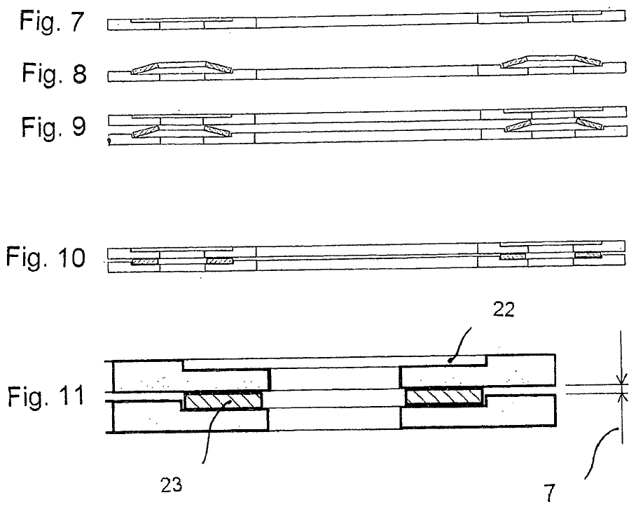

FIG. 7 is a cross section of a barrel element in which cutouts are formed for housing spacers.

FIG. 8 is a cross section identical to the cross section of FIG. 7 but with spacers in place.

FIG. 9 is a cross section representing a spacer between two barrel elements during the unclogging.

FIGS. 10 and 11 represent the parts of FIG. 9 but during an extrusion cycle.

Thus, the sludge to be densified (1) is brought into a hopper (2) in which there is arranged a first force-feeding screw (3).

The sludge subsequently passes into a duct (4) leading to the screw (5) of an extruder then it passes through the barrel (6) of said extruder to be compressed therein, it thus gives up its liquid and gaseous fraction through slots (7) formed in said barrel then is discharged through an opening (8) to a liquid pit (9).

The solid fraction of this sludge which has thus been densified is ejected through an extrusion nozzle (10) then it falls through an opening (11) into a densified sludge pit (12).

Said barrel (6) is composed of a stack of elements (13) and of elastic spacers (14) and is crossed through by several columns (15) allowing the alignment of these parts and this assembly is held by two base elements (10) and (16) each arranged at one of the ends of said stack. One of the base elements (10) also constitutes an extrusion nozzle.

During a compression cycle, an actuator (17) bears on said base element (10) and at the same time on said stack, thus compressing said elastic spacers and reducing the width of said slots to their filtration dimensions. The degree of compression of said spacers determines the width of said slots (7).

During an unclogging cycle, said actuator (17) relaxes its pressure on said base element (10) and at the same time the pressure on said stack, thus allowing said elastic spacers to return to their original thickness and widen said slots to their unclogging dimension.

Said barrel with its two base elements is arranged in a jacket (18) provided with two openings, of which one (8) is intended for the discharge of said liquid and gaseous fractions and the other (11) for the filtrate, that is to say the densified sludge fraction.

The method also comprises a motor (19) and a rotational speed reduction gear (20) for driving said extrusion screw (6);

Finally, (21) represents a frame supporting the extruder assembly.

The present description is nonlimiting and constitutes only one embodiment of the invention to which numerous modifications can be made without in any way departing from its scope, thus:
the minimum width of said slots is limited by the thickness of said spacers (14) when they are entirely flattened as is the case of Belleville washers; now, for some sludges to be treated, it is necessary to have slots of a width clearly finer than the thickness of a flattened washer. For this, a clearance (22) is formed in said elements (13), clearances in which said spacer (14) comes to be housed and, in this case, it is only the protruding part of said spacer or washer which determines the width of said slots,
said elements of the barrel can have all kinds of configurations, be produced in all kinds of materials, have all kinds of configurations or thicknesses,
said spacers can be Belleville washers or any kinds of washers or spring-forming parts,
said spacers can be produced in rubber or in all kinds of elastomers,
rigid and non-compressible spacers can be arranged together with compressible spacers thus limiting the width of said slots to the thickness of said non-compressible spacers.

1. A method for unclogging a slotted barrel of screw extruders used for sludge densification, each of said slotted barrels comprising a stack of hollow elements spaced apart by spacers, thus creating slots between said hollow elements through which liquid and gaseous fractions are expelled radially by virtue of pressure prevailing in said barrels under the effect of the rotation of said screw extruders, wherein:
said spacers exhibit an elasticity,
said elasticity allows said spacers to be compressed in order to reduce their thickness,
a reduction of said thicknesses results in a reduction of a width of said slots,
compression of said spacers is produced by an axial pressure exerted on said stack of hollow elements,
said pressure is exerted during an extrusion cycle, and
said pressure is relaxed during an unclogging cycle, thus facilitating the latter.

2. The method as claimed in claim 1, wherein said stack of hollow elements is compressed by an actuator.

3. The method as claimed in claim 1, wherein said spacers are Belleville washers.

4. The method as claimed in claim 1, wherein said spacers are produced in an elastomer.

5. The method as claimed in claim 1, wherein non-elastic and non-compressible spacers are arranged together with said elastic spacers between said hollow elements of said barrel, thus limiting the possible degree of compression of said elastic spacers.

6. The method as claimed in claim 1, further comprising means making it possible to produce said slots whose width is smaller than possible minimum widths obtained by the compression of said spacers and in that said means are the production of a clearance formed in said hollow elements of said barrel at a seat of said elastic spacers.
